(19) United States
(12) Patent Application Publication
(10) Pub. No.: US 2011/0013610 A1
(43) Pub. Date: Jan. 20, 2011

(54) COMMUNICATION METHOD AND WIRELESS APPARATUS USING THE COMMUNICATION METHOD

(76) Inventors: Yoshiyuki Otani, Gifu (JP); Yoshiharu Doi, Gifu (JP); Ken Nakaoka, Aichi (JP); Yumi Okamura, Gifu (JP)

Correspondence Address: MCDERMOTT WILL & EMERY LLP, 600 13TH STREET, N.W., WASHINGTON, DC, 20005-3096, US

(21) Appl. No.: 12/812,434

(22) PCT Filed: Dec. 12, 2008
(86) PCT No.: PCT/JP2008/003752

§ 371 Date: Sep. 30, 2010

(51) Int. Cl. H04W 84/02

(52) U.S. Cl. 370/338

(57) ABSTRACT

A wireless unit performs a frequency conversion process, a quadrature modulation process, and a quadrature detection process. A modem performs a modulation/demodulation process. A processing unit performs digital signal processing on a signal from the modem and on a signal to the modem. An image capturing unit acquires an external image and outputs the acquired image to a coding unit. The coding unit generates image data by performing a compression encoding process on the image received from the image capturing unit and outputs the image data to a control unit. The control unit controls the overall movement of a vehicle camera apparatus.

### TECHNICAL FIELD

The present invention relates to communication technology and particularly to a communication method of performing settings related to a wireless network of a wireless apparatus with other wireless apparatuses and to a wireless apparatus using the communication method.

### BACKGROUND ART

Recently, with the growing popularity of wireless LANs (Local Area Networks), there is a strong need for the reinforcement of security protection in a wireless LAN. For this reason, instead of developing WEP (Wired Equivalent Privacy), where the lengths of an encryption key or an initial vector (IV) are too short to ensure message integrity, a TKIP (Temporal Key Integrity Protocol) and WPA (Wi-Fi Protected Access) are developed so as to reinforce the security protection in a wireless LAN, wherein the TKIP can extend the length of an encryption key and periodically update the encryption key and wherein WPA employs a MIC (Message Integrity Code), which detects the falsification of a message.

WPA supports PSK (Pre-Shared Key) in order to achieve two-way authentication between wireless LAN apparatuses. In order to establish a wireless LAN network protected by a PSK, users are required to set a PSK both to access points (AP) and to clients to which the APs are connected. In addition to a PSK, users are required to configure many settings, for example, set an SSID (Service Set Identifier), which is the information used to identify a wireless LAN network, for the security protection of a wireless LAN network.

A WPS (Wi-Fi Protected Setup) is a simple connection method developed in order to reduce such burdens on a user. In a wireless LAN apparatus adaptable for a WPS, an SSID, WPA, etc., are configured by entering a personal identification number (PIN) or by push-button configuration (PBC). Using such a wireless LAN apparatus adaptable for a WPS, users can easily construct a secure wireless LAN network (for example, see non-patent document 1).

[Non-Patent Document 1] “Wi-Fi CERTIFIED for Wi-Fi Protected Setup: Great Improvement of User's Environment of a Wi-Fi Network in Standard Homes and Small Offices/Home Offices,” [online], 2007, Wi-Fi Alliance, Full Text, [Searched on Nov. 22, 2007], Internet <URL: http://www.wirelessethernet.org/files/kc/wp_{—}21_Wi-Fi_Protected_Setup_Whitepaper_ja.pdf>

### DISCLOSURE OF INVENTION

### Technical Problem

If two wireless apparatuses to be communicated with each other are both compliant with WPS, a secured wireless LAN network can be easily built when an external instruction for a simple connection is made on the two wireless apparatuses, for example, when the instruction is given by pressing a special purpose button. However, if at least one of the two wireless apparatuses is not compliant with WPS, the wireless apparatus cannot receive the instruction for a simple connection via the special purpose button. Thus, a procedure of the simple connection between the two wireless apparatuses cannot be performed. As a result, the settings of the two apparatuses become complicated.

In this background, a purpose of the present invention is to provide technology for reducing burden on the user for configuring settings even under an environment where a wireless apparatus that has a simple connection function and a wireless apparatus that does not have such a function both coexist.

### Means for Solving the Problems

A wireless apparatus according to one embodiment of the present invention comprises: a reception unit configured to receive, from another wireless apparatus for which a setting related to a wireless network is not configured, a request for making a transition into a preparation mode for preparing the setting; a first execution unit configured to make a transition into the preparation mode when the request received by the reception unit needs to be satisfied; a second execution unit configured, when the transition into the preparation mode is made by the first execution unit, to perform the setting related to the wireless network with said other wireless apparatus by making a transition into an execution mode for performing the setting upon the receipt of a setting request from said other wireless apparatus; and a communication unit configured to perform communication with said other wireless apparatus by making a transition into a communication mode for performing communication after the setting is performed by the second execution unit. The second execution unit rejects making the transition into the execution mode during the communication mode even when the second execution unit receives a setting request from another wireless apparatus.

Another embodiment of the present invention also relates to a wireless apparatus. The apparatus comprises: a first request unit configured to request another wireless apparatus, for which a setting related to a wireless network is not configured, to transition into a preparation mode for preparing the setting; a second request unit configured to request said other wireless apparatus to make a setting when said other wireless apparatus transitions into the preparation mode in accordance with the request from the first request unit; an execution unit configured to perform the setting related to the wireless network with said other wireless apparatus when said other wireless apparatus transitions into an execution mode for performing the setting in accordance with the request from the second request unit; and a communication unit configured to perform communication with said other wireless apparatus when said other wireless apparatus transitions into a communication mode for performing communication after the setting is performed by the execution unit.

Still another embodiment of the present invention relates to a communication method. The method comprises: receiving, from another wireless apparatus for which a setting related to the wireless network is not configured, a request for making a transition into a preparation mode for preparing the setting; making a transition into the preparation mode when the received request needs to be satisfied; performing, when the transition into the preparation mode is made, the setting related to a wireless network with said other wireless apparatus by making a transition into an execution mode for performing the setting upon the receipt of a setting request from said other wireless apparatus; and performing communication with said other wireless apparatus by making a transition into a communication mode for performing communication after the setting is performed. In performing the setting, the transition into the execution mode is rejected during the communication mode even when a setting request from another wireless apparatus is received.

Still another embodiment of the present invention also relates to a communication method. The method comprises: requesting another wireless apparatus, for which a setting related to a wireless network is not configured, to transition into a preparation mode for preparing the setting; requesting said other wireless apparatus to make a setting when said other wireless apparatus transitions into the preparation mode in accordance with the transition request; performing the setting related to the wireless network with said other wireless apparatus when said other wireless apparatus transitions into an execution mode for performing the setting in accordance with the setting request; and performing communication with said other wireless apparatus when said other wireless apparatus transitions into a communication mode for performing communication after the setting is performed.

Still another embodiment of the present invention also relates to a wireless apparatus. The apparatus comprises: an execution unit configured to perform a setting related to a wireless network with another wireless apparatus for which the setting related to the wireless network is not configured and to manage setting contents; and a communication unit configured to perform communication with said other wireless apparatus for which the setting is performed by the execution unit. The execution unit deletes setting contents for another wireless apparatus that has not performed communication with the communication unit over a certain period of time.

Still another embodiment of the present invention also relates to a communication method. The method comprises: performing a setting related to a wireless network with another wireless apparatus for which the setting related to the wireless network is not configured; managing the setting contents; and performing communication with said other wireless apparatus for which the setting is performed. In managing the setting contents, the setting contents are deleted for another wireless apparatus that has not performed communication over a certain period of time.

Optional combinations of the aforementioned constituting elements and implementations of the invention in the form of methods, apparatuses, systems, recording mediums, and computer programs may also be practiced as additional modes of the present invention.

According to the invention, the burden on the user for configuring settings can be reduced even under an environment where a wireless apparatus that has a simple connection function and a wireless apparatus that does not have such a function both coexist.

### BRIEF DESCRIPTION OF DRAWINGS

FIG. 1 is a diagram illustrating the configuration of a communication system according to an embodiment of the present invention;

FIG. 2 is a diagram illustrating the configuration of a vehicle monitor apparatus shown in FIG. 1;

FIG. 3 is a diagram illustrating the configuration of the control unit in FIG. 2;

FIG. 4 is a diagram illustrating the configuration of a vehicle camera apparatus shown in FIG. 1;

FIG. 5 is a diagram illustrating the configuration of the control unit in FIG. 4;

FIG. 6 is a sequence diagram illustrating a setting procedure in a communication system shown in FIG. 1;

FIG. 7 is a flowchart illustrating a setting procedure in the vehicle monitor apparatus shown in FIG. 2;

FIG. 8 is a flowchart illustrating a setting procedure in the vehicle camera apparatus shown in FIG. 4;

FIG. 9 is a diagram illustrating the configuration of a control unit according to the exemplary variation of the present invention;

FIG. 10 is a diagram illustrating a data structure of a list stored in a memory unit according to the exemplary variation of the present invention;

FIG. 11 is a sequence diagram illustrating a setting procedure in the communication system according to the exemplary variation of the subject invention; and

FIG. 12 is a flowchart illustrating a deletion procedure in the control unit shown in FIG. 9.

### EXPLANATION OF REFERENCE

10 vehicle camera apparatus

12 vehicle monitor apparatus

20 wireless unit

22 modem

24 processing unit

26 control unit

28 decoding unit

30 display unit

32 input unit

34 IF unit

36 memory unit

40 request unit

42 checking unit

44 execution unit

50 wireless unit

52 modem

54 processing unit

56 control unit

58 coding unit

60 image capturing unit

62 memory unit

70 communication-mode operation unit

72 preparation-mode operation unit

74 execution-mode operation unit

80 reception unit

82 setting unit

84 management unit

100 communication system

### BEST MODE FOR CARRYING OUT THE INVENTION

An outline of the present invention will be given before a specific description thereof. The embodiment of the present invention is a wireless communication system formed by a wireless apparatus that has a simple connection function (WPS: WiFi Protected Setup) (hereinafter, referred to as a “compliant apparatus”) and by a wireless apparatus that does not have a simple connection function (hereinafter, referred to as a “non-compliant apparatus”). Having a simple connection function corresponds to having a button or the like, which is used to accept from a user an instruction for performing a setting related to a wireless network. The wireless communication system corresponds to, for example, a wireless network such as a wireless LAN that complies with the IEEE 802.11 standard or the like. By a user pressing a special-purpose button provided on the compliant apparatus, the compliant apparatus requests a simple connection on a non-compliant apparatus. Since the non-compliant apparatus is not adapted for WPS, the non-compliant apparatus cannot determine the time to start the simple connection and thus cannot perform the process necessary for the simple connection with the compliant apparatus. In order to build a secured wireless network, it is necessary to reject a simple connection request from a wireless apparatus that is not to be communicated with.

Therefore, the non-compliant apparatus may perform an operation corresponding to the simple connection with the compliant apparatus as long as a predetermined condition is satisfied. The predetermined condition is, for example, such that a predetermined period of time has not been reached since the request for a simple connection has been made by the compliant apparatus and such that the compliant apparatus that has made the request is required to be connected. Even when the non-compliant apparatus is not adapted for WPS, this allows the compliant apparatus to achieve the simple connection and allows for a secured wireless network to be easily built. Since the simple connection is achieved only with the compliant apparatus to be connected with, it is ensured that a secured wireless network will be built. A non-limited period of time for performing the simple connection and improvements of the security are further required. The “simple connection” includes a connection protocol that complies with WPS as defined in “Wi-Fi Protected Setup Specification 1.0”, Wi-Fi Alliance, <URL: http://www.wi-fi.org/wifi-protected-setup>. Since the connection protocol is defined in detail in the above-stated written standards, the explanation thereof is omitted.

In addition to a “communication mode” for a communication and an “execution mode” for performing a process corresponding to the simple connection, the non-compliant apparatus according to the embodiment of the present invention defines a “preparation mode,” which is the step before the execution mode. The non-compliant apparatus operates so that it does not enter into the execution mode without first entering into the preparation mode. On the other hand, the compliant apparatus gives notification of a signal for requesting the transition into the preparation mode upon the receipt of a user instruction given by a push of the special-purpose button. The non-compliant apparatus checks its own connection state upon the receipt of the request and then enters into the preparation mode when the non-compliant apparatus is not connected to any other apparatuses or when there is no apparatus with which to be connected in the neighborhood. When the non-compliant apparatus enters into the preparation mode, the compliant apparatus transmits a connection request to the non-compliant apparatus, and the non-compliant apparatus then enters into the execution mode in response to the transmission. The non-compliant apparatus transitions into the execution mode when the compliant apparatus that has requested the transition into the preparation mode is the same as the compliant apparatus that has transmitted the connection request. Then, the simple connection is then performed between the two.

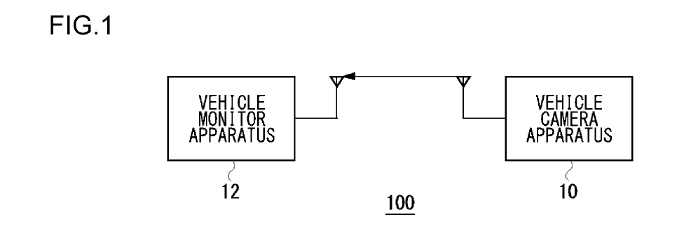

FIG. 1 shows the configuration of a communication system 100 according to the embodiment of the present invention. The communication system 100 includes a vehicle camera apparatus 10 and a vehicle monitor apparatus 12. The vehicle monitor apparatus 12 corresponds to the above-stated compliant apparatus, and the vehicle camera apparatus 10 corresponds to the above-stated non-compliant apparatus. The vehicle camera apparatus 10 captures the image of a moving image or a still image (hereinafter, generically referred to as an “image”) and transmits the captured image data (hereinafter, referred to as “image data”) to the vehicle monitor apparatus 12. As described above, a wireless LAN is used for a wireless network between the vehicle camera apparatus 10 and the vehicle monitor apparatus 12. The vehicle monitor apparatus 12 receives image data from the vehicle camera apparatus 10 and displays the image on the monitor. The vehicle monitor apparatus 12 is adapted for the simple connection of WPS and includes a button (not shown) in order for a user to give instructions to execute the simple connection.

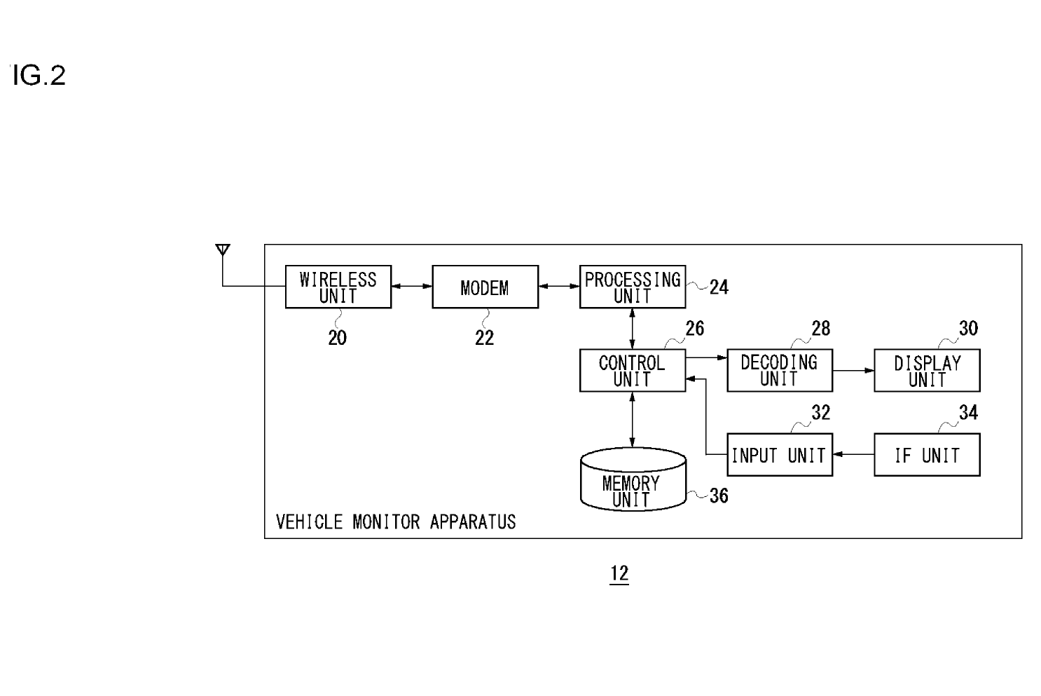

FIG. 2 shows the configuration of the vehicle monitor apparatus 12. The vehicle monitor apparatus 12 includes a wireless unit 20, a modem 22, a processing unit 24, a control unit 26, a decoding unit 28, a display unit 30, an input unit 32, an IF unit 34, and a memory unit 36.

The wireless unit 20 performs communication with the vehicle camera apparatus 10, which is not shown. Acting to perform a reception process, the wireless unit 20 performs frequency conversion on a wireless frequency signal received via an antenna and generates a baseband signal. Furthermore, the wireless unit 20 outputs the baseband signal to the modem 22. In general, a baseband signal is formed by both an in-phase component and an orthogonal component, and two signal lines should thus be shown. However, for the purpose of clarifying the figure, only one signal line is shown. The wireless unit 20 also includes an LNA (Low Noise Amplifier), a mixer, an AGC, and an A/D converter. Acting to perform a transmission process, the wireless unit 20 performs frequency conversion on a baseband signal input from the modem 22 and generates a wireless frequency signal. Furthermore, the wireless unit 20 transmits the wireless frequency signal from an antenna. The wireless unit 20 also includes a PA (Power Amplifier), a mixer, and a D/A converter.

Acting to perform a reception process, the modem 22 performs modulation on the baseband signal from the wireless unit 20. Furthermore, the modem 22 outputs a result of modulation to the processing unit 24. Acting to perform a transmission process, the modem 22 performs modulation on a signal from the processing unit 24. Furthermore, the modem 22 outputs the result of modulation to the wireless unit 20 as a baseband signal. When the communication system 100 corresponds to an OFDM modulation method such as an IEEE802.11a standard, the modem 22 performs an FFT as a reception process and performs an IFFT as a transmission process. When the communication system 100 corresponds to a spread spectrum method such as the IEEE802.11b standard, the modem 22 performs back-diffusion, which acts as a reception process, and performs diffusion, which acts as a transmission process. Moreover, when the communication system 100 corresponds to an MIMO method such as an IEEE802.11n, the modem 22 performs adaptive array signal processing, which acts as a reception process and performs distributed processing on multiple streams, which acts as a transmission process.

The processing unit 24 performs digital signal processing on the signal from the modem 22 and on the signal to the modem 22. An example of the digital signal processing is error correction coding, acting as a transmission process or error correction decoding, acting as a reception process. The digital signal processing is not limited to these processes. The processing unit 24 outputs to the control unit 26 the result of performing digital signal processing on the signal from the modem 22 and inputs from the control unit 26 a signal used as a basis for the signal to the modem 22. As described above, the wireless unit 20 through the processing unit 24 all perform communication with the vehicle camera apparatus 10, which is not shown, by connecting to a wireless network, which is not shown.

The control unit 26 controls the overall movement of the vehicle monitor apparatus 12. Upon the receipt of the instruction from a user requesting the simple connection, the control unit 26 performs communication with the vehicle camera apparatus 10, which is not shown. In other words, the control unit 26 performs, by the simple connection, the setting related to the wireless network with the vehicle camera apparatus 10 for which no setting related to the wireless network is performed. The setting related to the wireless network is a setting required for the security protection of a PSK, an SSID, etc., as previously described. The descriptions of these processes will be made hereinafter. Furthermore, the control unit 26 receives the image data from the vehicle camera apparatus 10 and displays the image on the display unit 30 during communication with the vehicle camera apparatus 10.

The control unit 26 receives the result of digital signal processing from the processing unit 24, acting as an output process, and outputs the result to the decoding unit 28. The decoding unit 28 reproduces an image by decoding the image data that has been coded by the vehicle camera apparatus 10, which is not shown. The decoding unit 28 outputs the reproduced image to the display unit 30. The display unit 30 is configured by an LCD (Liquid Crystal Display), etc. The display unit 30 receives the image from the decoding unit 28 and then displays the image.

The IF unit 34 is configured by a button and the like and receives an instruction from a user. The IF unit 34 corresponds to the previously-stated special-purpose button and receives from a user an instruction requesting PBC, in other words, an instruction requesting a simple connection. This corresponds to a user's pressing of a push button. The input unit 32 detects the instruction requesting the PBC received by the IF unit 34. Although the input unit 32 detects instructions other than the instruction for requesting the PBC, a detailed description will be made mainly regarding the instruction for requesting the PBC. The control unit 26 receives an instruction signal from the input unit 32, acting as an input process and outputs the corresponding data to the processing unit 24.

The memory unit 36 stores the identification information of the vehicle camera apparatus 10 to be communicated. The identification information is, for example, a MAC address or an IP address. The memory unit 36 is enabled to record by an external instruction given to disable write protection and is disabled to record by an external instruction given to enable write protection.

The configuration is implemented in hardware by any CPU of a computer, memory, or other LSI's and in software by a program having a communication function or the like loaded into the memory. Functional blocks are implemented by the cooperation of hardware and software. Thus, a person skilled in the art should appreciate that there are many ways of accomplishing these functional blocks in various forms in accordance with the components of hardware only, software only, or the combination of both.

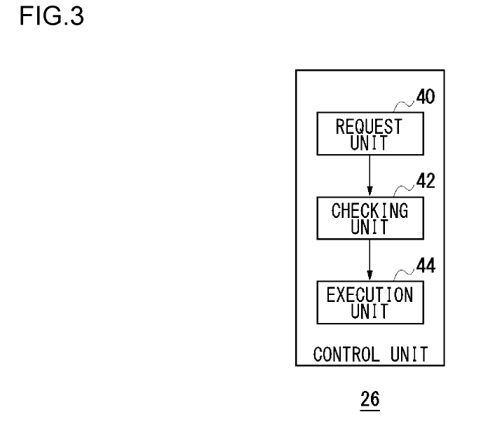

FIG. 3 shows the configuration of the control unit 26. The control unit 26 includes a request unit 40, a checking unit 42, and an execution unit 44. A detailed description will be made mainly regarding the simple connection among the processes performed by the control unit 26. The request unit 40 receives an instruction requesting the PBC from the input unit 32 (not shown). The request unit 40 is the vehicle camera apparatus 10 (not shown) and requests the vehicle camera apparatus 10, for which a setting related to a wireless network is not made, the transition into the preparation mode for preparing the setting. The signal used for requesting is referred to as a “preparation-mode-transition instruction signal.” The request unit 40 includes the information for identifying the source, that is, the vehicle monitor apparatus 12 in the preparation mode transition instruction signal. The information for identifying the vehicle monitor apparatus 12 corresponds to the identification information for identifying the vehicle monitor apparatus 12. The request unit 40 gives notification of the preparation-mode-transition instruction signal via the processing unit 24 through the wireless unit 20.

When the vehicle camera apparatus 10 (not shown) transitions into the preparation mode in accordance with the preparation mode transition instruction signal transmitted from the request unit 40, the checking unit 42 receives a signal indicating that the vehicle camera apparatus 10 has transmitted into the preparation mode (hereinafter, referred to as a “preparation-mode-transition completion s The preparation-mode-transition completion signal reaches the checking unit 42 via the wireless unit 20 through the processing unit 24. The checking unit 42 confirms the transition of the vehicle camera apparatus 10 into the preparation mode by receiving the preparation-mode-transition completion signal. The checking unit 42 notifies the execution unit 44 of information indicating that the confirmation has been made.

Upon the receipt from the checking unit 42 of the information indicating that the confirmation has been made, the execution unit 44 generates a signal for requesting the setting (hereinafter, referred to as a “setting request signal”). The execution unit 44 transmits the setting request signal to the vehicle camera apparatus 10 via the processing unit 24 through the wireless unit 20. The execution unit 44 includes the information for identifying the source, that is, the vehicle monitor apparatus 12 in the preparation-mode-transition completion signal. Thus, similar information is included in the preparation-mode-transition instruction signal and the setting request signal. When the vehicle camera apparatus 10 transitions into the execution mode for performing the setting in accordance with the setting request signal, the execution unit 44 performs the setting related to the wireless network with the vehicle camera apparatus 10. For example, upon the receipt of a response signal from the vehicle camera apparatus 10 via the wireless unit 20 through the processing unit 24 after the transmission of the setting request signal, the execution unit 44 recognizes that the vehicle camera apparatus 10 has been transitioned into the execution mode. A publicly-known technique needs to be used for the setting process related to the wireless network. Thus, the explanation thereof is omitted.

The details of the setting related to the wireless network made by the execution unit 44 are stored in the memory unit 36 (not shown). When the vehicle camera apparatus 10 transitions into the communication mode for communication after performing the setting in the execution unit 44, the control unit 26 communicates with the vehicle camera apparatus 10. The control unit 26 may recognize that the vehicle camera apparatus 10 has transitioned into the communication mode when the setting process in the execution unit 44 is completed. The control unit 26 uses the details of the setting stored in the memory unit 36 in the case of communication. The preparation mode, the execution mode, and the communication mode of a vehicle camera apparatus 10 will be described hereinafter.

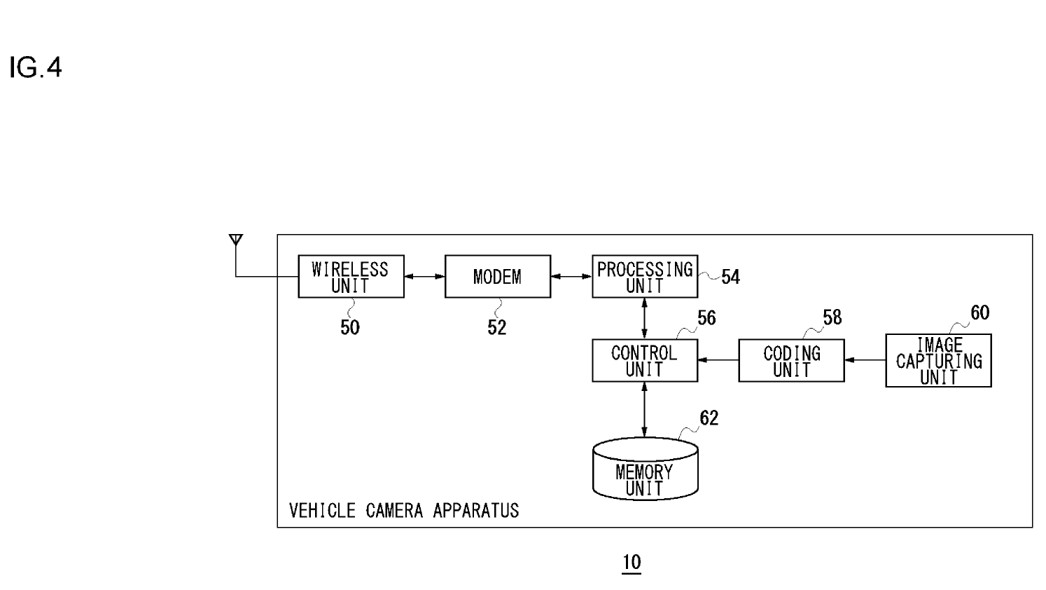

FIG. 4 shows the configuration of the vehicle camera apparatus 10. The vehicle camera apparatus 10 includes a wireless unit 50, a modem 52, a processing unit 54, a control unit 56, a coding unit 58, an image capturing unit 60, and a memory unit 62. The wireless unit 50, the modem 52, and the processing unit 54 are similar in type to the wireless unit 20, the modem 22, and the processing unit 24, respectively. Thus, the explanation thereof is omitted.

The image capturing unit 60 corresponds to a CCD (Charge Coupled Device) image sensor and the like and acquires an image from the outside. The image capturing unit 60 outputs an acquired image to the coding unit 58. The coding unit 58 generates image data by performing a compression encoding process on the image received from the image capturing unit 60. As a compression method, for example, a Motion JPEG (Joint Photographic Experts Group) or the like is used. The coding unit 58 outputs the image data to the control unit 56.

The control unit 56 controls the overall movement of the vehicle camera apparatus 10. For example, the control unit 56 defines the communication mode, the preparation mode, and the execution mode for the operations of the vehicle camera apparatus 10 and controls both the operations of these modes and the transition among the modes. The descriptions thereof will be made hereinafter. The control unit 56 outputs the image data received from the coding unit 58 to the processing unit 54 during the communication mode. The memory unit 62 stores the identification information of the vehicle monitor apparatus 12 to be communicated. The identification information is, for example, a MAC address or an IP address.

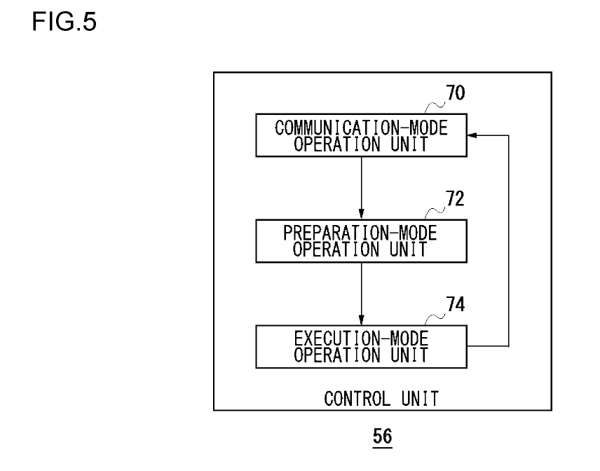

FIG. 5 shows the configuration of the control unit 56. The control unit 56 includes a communication-mode operation unit 70, a preparation-mode operation unit 72, and an execution-mode operation unit 74. The communication-mode operation unit 70 executes the communication mode for the operation of the vehicle camera apparatus 10. In the communication mode, the wireless unit 50 through the processing unit 54 communicate with the vehicle monitor apparatus 12. Giving a detailed description, the communication-mode operation unit 70 outputs the image data received from the coding unit 58 and transmits the image data to the processing unit 54 through the wireless unit 50.

The communication mode is set even when the actual communication is not taking place. The communication-mode operation unit 70 receives, via the wireless unit 50 through the processing unit 54, the preparation-mode-transition instruction signal from the vehicle monitor apparatus 12 for which the setting related to the wireless network with the vehicle monitor apparatus 12 is not made. As previously described, the preparation-mode-transition instruction signal corresponds to the request for the transition into the preparation mode for preparing the setting. The communication-mode operation unit 70 outputs the received preparation-mode-transition instruction signal to the preparation-mode operation unit 72.

The preparation-mode operation unit 72 receives the preparation-mode-transition instruction signal from the communication-mode operation unit 70. The preparation-mode operation unit 72 checks whether there is any apparatus to be connected with. Giving a detailed description, the preparation-mode operation unit 72 gives notification of a probe request via the processing unit 54 through the wireless unit 50. The preparation-mode operation unit 72 determines that there is an apparatus to be connected with when the preparation-mode operation unit 72 receives a probe response within a predetermined period of time via the wireless unit 50 through the processing unit 54. The preparation-mode operation unit 72 transitions into the preparation mode in accordance with the preparation-mode-transition instruction signal when there is no apparatus to be connected with. The preparation mode can transition into the execution mode that is described hereinafter.

The preparation-mode-transition instruction signal includes the information for identifying the vehicle monitor apparatus 12, which is a source, and the preparation-mode operation unit 72 stores the information in the control unit 56 (not shown). After transitioning into the preparation mode, the preparation-mode operation unit 72 receives the setting request signal from the vehicle monitor apparatus 12 via the wireless unit 50 through the processing unit 54. The preparation-mode operation unit 72 outputs the received setting request signal to the execution-mode operation unit 74. When the preparation-mode operation unit 72 does not receive the setting request signal within a predetermined period of time after it enters into the preparation mode, the preparation-mode operation unit 72 allows the communication-mode operation unit 70 to return to the communication mode. On the other hand, when there is an apparatus to be connected with, the preparation-mode operation unit 72 keeps the communication-mode operation unit 70 to stay in the communication mode, without following the preparation-mode-transition instruction signal.

The execution-mode operation unit 74 receives a setting request signal from the preparation-mode operation unit 72. After that, the execution-mode operation unit 74 transitions into the execution mode. The execution mode is for performing the setting related to a wireless network among the vehicle monitor apparatus 12. The execution-mode operation unit 74 performs the setting related to the wireless network among the vehicle monitor apparatuses 12 by transitioning into the execution mode. As previously described, a publicly-known technique needs to be used for the setting process, and the explanation thereof is thus omitted. The setting request signal includes the information for identifying the vehicle monitor apparatus 12, which is a source, in the same way the preparation-mode-transition instruction signal does.

The execution-mode operation unit 74 transitions into the execution mode when the information stored in the control unit 56 and the information included in the setting request signal are the same. This corresponds to the transition into the execution mode when the vehicle monitor apparatus 12 that has transmitted the request for making a transition into the preparation mode and the vehicle monitor apparatus 12 that has transmitted the setting request are the same. On the other hand, the execution-mode operation unit 74 rejects the transition into the execution mode when the both sets of information are not the same. When being in the communication mode, the execution-mode operation unit 74 rejects the transition into the execution mode even when it has received the setting request signal from the vehicle monitor apparatus 12 and keeps the communication-mode operation unit 70 from leaving the communication mode. After performing the setting in the execution-mode operation unit 74, the communication-mode operation unit 70 communicates with the vehicle monitor apparatus 12 by transitioning into the communication mode.

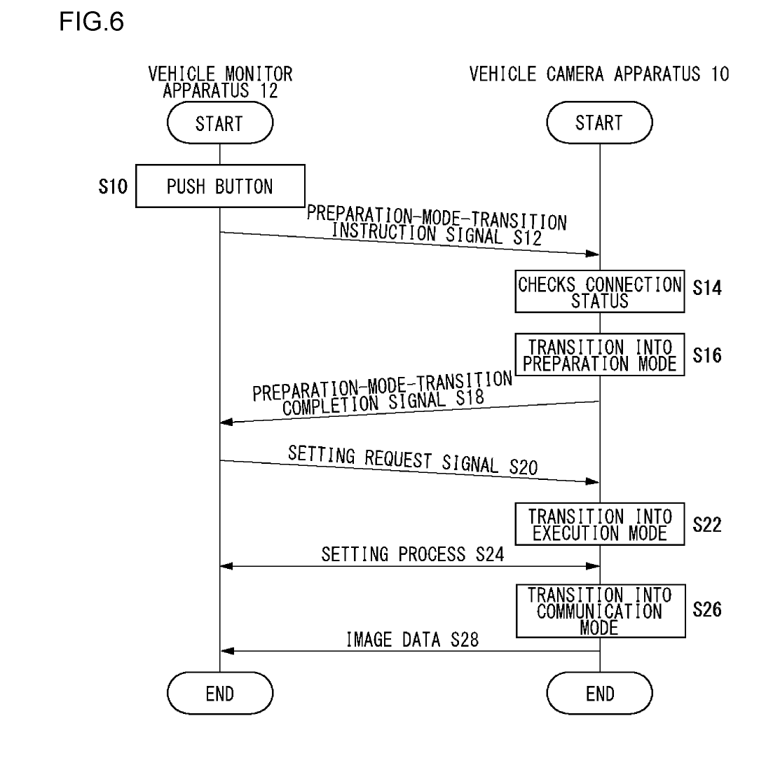

An explanation is given of the operation of the communication system 100 having the above-stated configuration. FIG. 6 is a sequence diagram showing a setting procedure in the communication system 100. The vehicle monitor apparatus 12 detects a push of a button (S10). The vehicle monitor apparatus 12 gives notification indicating a preparation-mode-transition instruction signal (S12). The vehicle camera apparatus 10 checks the connection status (S14) and transitions into the preparation mode (S16). The vehicle camera apparatus 10 transmits the preparation-mode-transition completion signal to the vehicle monitor apparatus 12 (S18). The vehicle monitor apparatus 12 transmits the setting request signal to the vehicle camera apparatus 10 (S20). Upon the receipt of the setting request signal, the vehicle camera apparatus 10 transitions into the execution mode (S22). After this, the vehicle camera apparatus 10 and the vehicle monitor apparatus 12 perform the setting process (S24). After the completion of the setting process, the vehicle camera apparatus 10 transitions into the communication mode (S26). The vehicle camera apparatus 10 transmits the image data to the vehicle monitor apparatus 12 (S28).

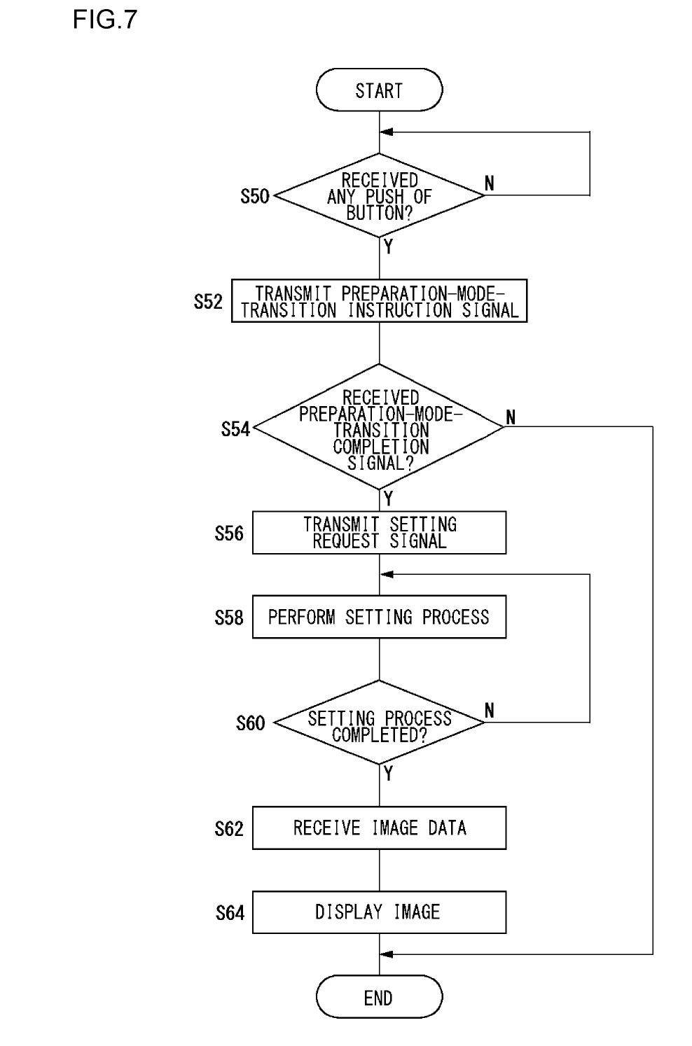

FIG. 7 is a flowchart illustrating a setting procedure in the vehicle monitor apparatus 12. The input unit 32 is on stand-by when it does not receive any push of the button (N in S50). When the input unit 32 receives the push of the button (Y in S50), the request unit 40 transmits the preparation-mode-transition instruction signal via the processing unit 24 through the wireless unit 20 (S52). Upon the receipt of the preparation-mode-transition completion signal via the wireless unit 20 through the processing unit 24 (Y in S54), the checking unit 42 transmits the setting request signal via the processing unit 24 through the wireless unit 20 (S56). After this, the execution unit 44 performs the setting process (S58). If the setting process is not completed (N in S60), the step goes back to Step S58. When the setting process is completed (Y in S60), the wireless unit 20 through the control unit 26 all receive the image data (S62). The decoding unit 28 decodes the image data, and the display unit 30 displays the image (S64). On the other hand, when the checking unit 42 does not receive the preparation-mode-transition completion signal via the wireless unit 20 through the processing unit 24 (N in S54), the process is terminated.

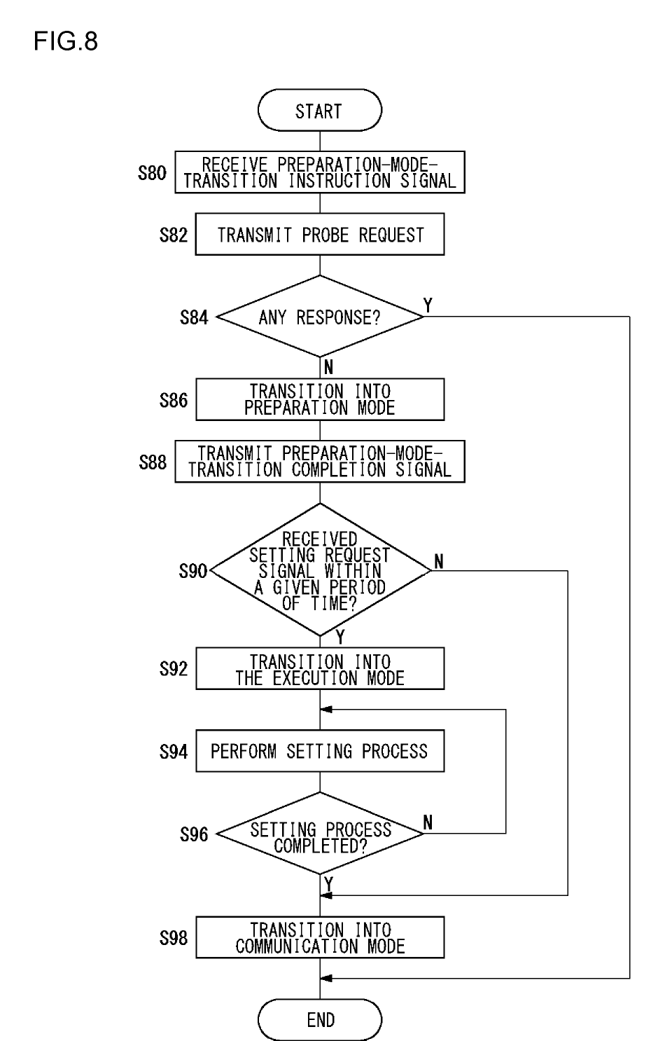

FIG. 8 is a flowchart illustrating a setting procedure in the vehicle camera apparatus 10. The communication-mode operation unit 70 receives the preparation-mode-transition instruction signal via the wireless unit 50 through the processing unit 54 (S80). The preparation-mode operation unit 72 transmits a probe request via the processing unit 54 through the wireless unit 50 (S82). The preparation-mode operation unit 72 transitions into the preparation mode (S86), when there is no response (N in S84). The preparation-mode operation unit 72 transmits a preparation-mode-transition completion signal via the processing unit 54 through the wireless unit 50 (S88). When the preparation-mode operation unit 72 receives a setting request signal within a given period of time via the wireless unit 50 through the processing unit 54 (Y in S90), the execution-mode operation unit 74 transitions into the execution mode (S92).

The execution-mode operation unit 74 performs a setting process (S94). If the setting process is not completed (N in S96), the step goes back to Step S94. When the setting process is completed (Y in S96), the communication-mode operation unit 70 transitions into the communication mode (S98). When the preparation-mode operation unit 72 does not receive a setting request signal within a given period of time via the wireless unit 50 through the processing unit 54 (N in S90), the communication-mode operation unit 70 transitions into the communication mode (S98). When there is a response mode (Y in S84), the preparation-mode operation unit 72 keeps the communication-mode operation unit 70 from leaving the communication mode and completes the process.

An exemplary variation of the present invention is described in detail in the following. In the embodiment, the communication mode, the preparation mode, and the execution mode are defined in the non-compliant apparatus so that the apparatus does not enter into the execution mode without first entering into the preparation mode, thereby improving the security. On the other hand, in the exemplary variation, the non-compliant apparatus performs a setting process with the compliant apparatus to which a setting request has been made. Then, the non-compliant apparatus cancels the setting with a compliant apparatus that has not performed communication over a certain period of time. The same applies to the compliant apparatus. In other words, taking the characteristics of an application into consideration, a wireless apparatus performs the setting process with all other wireless apparatuses that have responded and lists the setting contents (hereinafter, the setting contents that are listed are referred to as a “list”). After a predetermined period of time, the wireless apparatus keeps only the setting contents related to other wireless apparatuses with which the wireless apparatus in communication. Even when vehicle movement allows for a setting process to be temporarily performed with other apparatus installed in another vehicle, communication with said other wireless apparatus is generally disrupted over time with the movement of the vehicle. As a result, the deletion of such setting contents related to another wireless apparatus improves security.

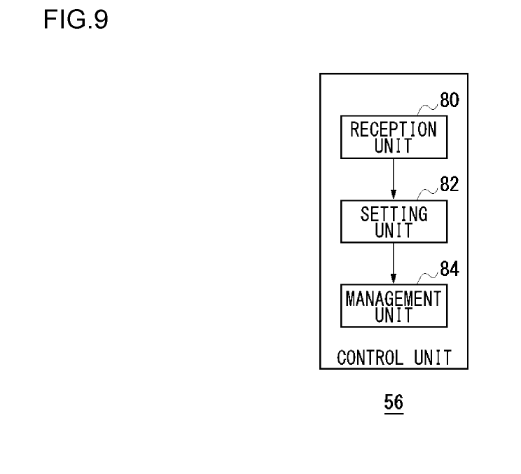

The communication system 100, the vehicle monitor apparatus 12, and the vehicle camera apparatus 10 according to the exemplary variation are similar in type to those of FIGS. 1, 2, and 4, respectively. For this reason, a detailed description will now be made mainly regarding the differences. FIG. 9 illustrates the configuration of a control unit 56 according to the exemplary variation of the subject invention. The control unit 56 includes a reception unit 80, a setting unit 82, and a management unit 84.

The reception unit 80 receives, via the wireless unit 50 through the processing unit 54, a setting request from the vehicle monitor apparatus 12 for which the setting related to the wireless network is not made. The setting request corresponds to the previously-stated setting request signal. The reception unit 80 outputs, to the setting unit 82, a signal indicating the reception of the setting request signal. Upon the entry of a signal indicating that the setting request signal has been received from the reception unit 80, the setting unit 82 performs the setting related to the wireless network among the vehicle monitor apparatuses 12 via the wireless unit 50 through the processing unit 54. Such a setting corresponds to the previously-stated process in an execution mode. A publicly-known technique needs to be used for the setting process, so the explanation thereof is thus omitted.

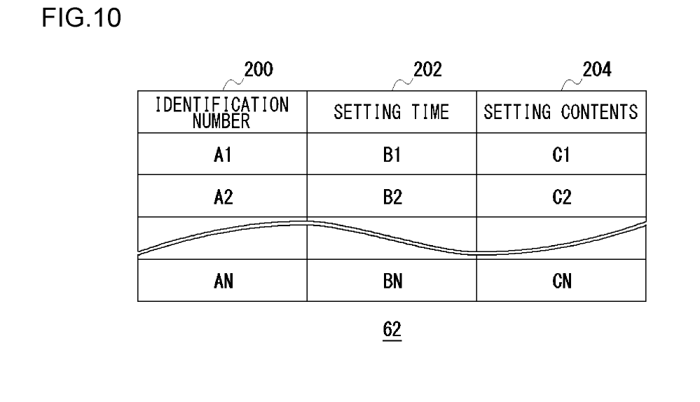

The management unit 84 manages the contents of the setting made by the setting unit 82 for the vehicle monitor apparatus 12. The management unit 84 stores the setting contents in the memory unit 62 (not shown). FIG. 10 illustrates the data structure of a list stored in a memory unit 62 according to the exemplary variation of the present invention. As shown in the figure, the data structure includes an identification-number column 200, a setting-time column 202, and a setting-content column 204. An identification number for identifying the vehicle monitor apparatus 12 is shown in the identification-number column 200. The setting contents corresponding to the vehicle monitor apparatus 12 are shown in the setting-content column 204. Furthermore, the time at which the setting contents are created is shown in the setting-time column 202. When communication with the vehicle monitor apparatus 12 is performed, the management unit 84 updates the time for the vehicle monitor apparatus 12 in the setting-time column 202. In other words, the setting-time column 202 shows the latest communication time. FIG. 9 is referred back.

After such a setting is made, the control unit 56 controls communication with the vehicle monitor apparatus 12 for which the setting is made. As previously described, the control unit 56 outputs the image data received from the coding unit 58 to the processing unit 54. The control unit 56 transmits the image data from the processing unit 54 to the wireless unit 50. The control unit 56 uses the setting contents stored in the memory unit 62 at the same time. During the course of communication, the management unit 84 identifies a vehicle monitor apparatus 12 that has not performed communication over a certain period of time. For example, the management unit 84 clocks the current time and derives the difference between the time in the setting-time column 202 stored in the memory unit 62 and the current time. The management unit 84 identifies a vehicle monitor apparatus 12 for which the difference exceeds a threshold value set in advance. Furthermore, the management unit 84 deletes the setting contents for the identified vehicle monitor apparatus 12 from the memory unit 62. The control unit 26 included in the vehicle camera apparatus 10 also transmits a setting request signal. Regarding the rest, the control unit 26 operates in a similar manner as the control unit 56. Therefore, the above explanation made regarding the control unit 56 is also valid for the control unit 26.

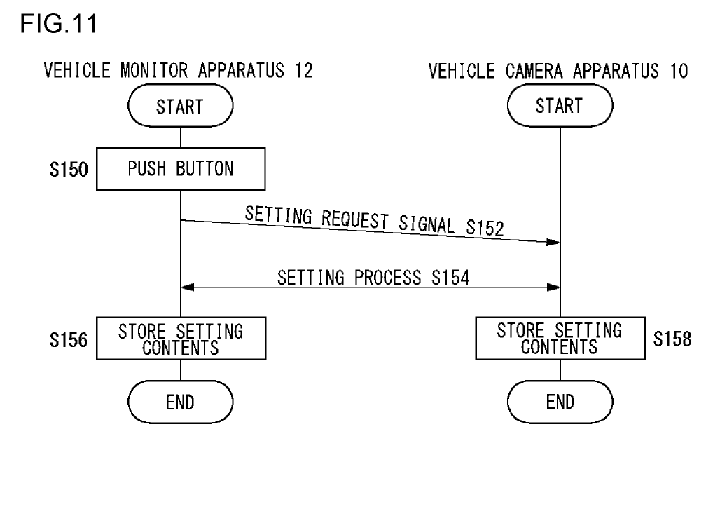

An explanation is given of the operation of the communication system 100 having the above-stated configuration. FIG. 11 is a sequence diagram illustrating a setting procedure in the communication system 100 according to the exemplary variation of the subject invention. The vehicle monitor apparatus 12 detects the push of a button (S150). The vehicle monitor apparatus 12 broadcasts the setting request signal (S152). When the vehicle camera apparatus 10 receives the setting request signal, the vehicle camera apparatus 10 and the vehicle monitor apparatus 12 perform the setting process (S154). The vehicle monitor apparatus 12 stores the setting contents in the memory unit 36 (S156), and the vehicle camera apparatus 10 stores the setting contents in the memory unit 62 (S158).

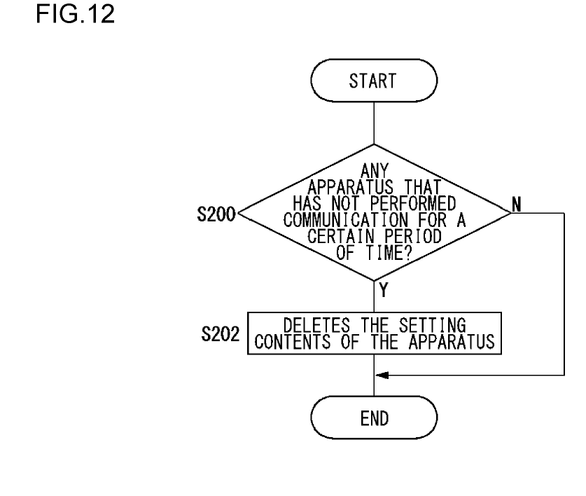

FIG. 12 is a flowchart illustrating a deletion procedure in the control unit 56. When there is any apparatus that has not performed communication for a certain period of time (Y in S200), the management unit 84 deletes the setting contents of the apparatus from the memory unit 62 (S202). On the other hand, when there is no apparatus that has not performed communication for a certain period of time (N in S200), the management unit 84 completes the process.

According to the embodiment of the subject invention, an apparatus does not enter into the execution mode without first entering into the preparation mode. Thus, the operation opportunity of the execution mode can be limited. Since there is a limited opportunity for the operation of the execution mode, security can be improved. The transition of a mode into the preparation mode allows for the mode to transition into the execution mode. Thus, the setting can be performed as necessary. Since the setting is performed as necessary, user-friendliness can be improved. When an apparatus does not enter into the execution mode via the preparation mode, the apparatus stays in the communication mode. Thus, communication can continue. The apparatus transitions into the execution mode when the vehicle monitor apparatus that has transmitted a request for making a transition into the preparation mode and the vehicle monitor apparatus 12 that has transmitted the setting request signal are the same, allowing for security to be improved. Since the execution mode is performed after going through the preparation mode, the certainty and the user-friendliness in establishing a communication session can be improved even when one wireless apparatus is adapted for WPS and the rest of wireless apparatuses are not adapted for WPS.

The burden on users of configuring settings can be reduced even when one wireless apparatus is adapted for WPS and the rest of wireless apparatuses are not adapted for WPS. A wireless network can be easily established even when one wireless apparatus is adapted for WPS and the rest of wireless apparatuses are not adapted for WPS. The deletion of the setting contents for a wireless apparatus that has not performed communication for a certain period of time allows for the deletion of the setting contents even when a setting is erroneously made. Since the setting contents are deleted even when the setting is erroneously made, security can be improved. Since the setting contents are automatically deleted, user-friendliness can be improved. Since the setting is performed in response to a setting request, the promptness of the setting can be improved. Since the setting is performed in response to a setting request, the setting process can be made simple. Since a simple process is performed, the process can be performed without fail.

Described above is an explanation based on the exemplary embodiments of the present invention. These exemplary embodiments are intended to be illustrative only, and it will be obvious to those skilled in the art that various modifications to constituting elements and processes could be developed and that such modifications are also within the scope of the present invention.

In the embodiment of the subject invention, the control unit 56 controls the switching of the communication mode, the preparation mode, and the execution mode. On the other hand, in the exemplary variation of the subject invention, the control unit 56 deletes the setting contents for a wireless apparatus that is not communicating even after the setting is once performed. However, the exemplary variation is not limited to this example. For example, the control unit 56 may perform the combination of the above processes. In other words, when performing a new setting, the control unit 56 controls the switching of the preparation mode and the execution mode and deletes the setting contents for a wireless apparatus that is not communicating after the setting is once performed. The exemplary variation allows for security measures when a setting is newly performed and for security measures after a setting is performed. Thus, security can be improved.

In the embodiment of the present invention, one communication system 100 is shown that includes the vehicle camera apparatus 10 and the vehicle monitor apparatus 12. However, the embodiment is not limited to this example. For example, the vehicle camera apparatus 10 and the vehicle monitor apparatus 12 may further perform the following process when there are a plurality of communication systems 100 located nearby. In a similar manner as the embodiment, after the communication-mode operation unit 70 of the vehicle camera apparatus 10 receives a preparation-mode-transition instruction signal, the preparation-mode operation unit 72 transitions into the preparation mode and transmits a preparation-mode-transition completion signal. Upon the receipt of a preparation-mode-transition instruction signal from another vehicle monitor apparatus 12 over a certain period of time after the transition into the preparation mode, the preparation-mode operation unit 72 transmits a preparation-mode-transition completion signal. In other words, the preparation-mode operation unit 72 can transmit a preparation-mode-transition completion signal to a plurality of vehicle monitor apparatuses 12.

Upon the receipt of the preparation-mode-transition completion signal, the checking unit 42 in the vehicle monitor apparatus 12 stands by for a certain period of time and receives a preparation-mode-transition completion signal from another vehicle camera apparatus 10. The checking unit 42 displays on the display unit 30 a list of the vehicle camera apparatus 10 from which the preparation-mode-transition completion signal is received. After the list is displayed, the checking unit 42 receives an instruction related to the selection of a vehicle camera apparatus 10 from a user via the IF unit 34. The processing unit 24 transmits a setting request signal to the vehicle camera apparatus 10, which is specified in the received instruction. Upon the receipt of the setting request signal, the preparation-mode operation unit 72 in the vehicle monitor apparatus 12 specifies the vehicle camera apparatus 10 corresponding to the transmission source of the setting request signal. According to the exemplary variation, the setting related to a wireless network can be easily performed even when there are a plurality of communication systems 100 located nearby.

### INDUSTRIAL APPLICABILITY

According to the invention, the burden on users for configuring settings can be reduced even under an environment where a wireless apparatus that has a simple connection function and a wireless apparatus that does not have such a function both coexist.

1. A wireless apparatus comprising:
a reception unit configured to receive, from another wireless apparatus for which a setting related to a wireless network is not configured, a request for making a transition into a preparation mode for preparing the setting;
a first execution unit configured to make a transition into the preparation mode when the request received by the reception unit needs to be satisfied;
a second execution unit configured, when the transition into the preparation mode is made by the first execution unit, to perform the setting related to the wireless network with said other wireless apparatus by making a transition into an execution mode for performing the setting upon the receipt of a setting request from said other wireless apparatus; and
a communication unit configured to perform communication with said other wireless apparatus by making a transition into a communication mode for performing communication after the setting is performed by the second execution unit, wherein
the second execution unit rejects making the transition into the execution mode during the communication mode even when the second execution unit receives a setting request from said other wireless apparatus.

2. The wireless apparatus according to claim 1 wherein the first execution unit stays in the communication mode when the request received by the reception unit does not need to be satisfied.

3. The wireless apparatus according to claim 2 wherein the execution unit makes a transition into the execution mode when another wireless apparatus that has transmitted a request for a transition into the preparation mode and another wireless apparatus that has transmitted the setting request are the same.

4. A wireless apparatus comprising:
a first request unit configured to request another wireless apparatus, for which a setting related to a wireless network is not configured, to transition into a preparation mode for preparing the setting;
a second request unit configured to request said other wireless apparatus to make a setting when said other wireless apparatus transitions into the preparation mode in accordance with the request from the first request unit;
an execution unit configured to perform the setting related to the wireless network with said other wireless apparatus when said other wireless apparatus transitions into an execution mode for performing the setting in accordance with the request from the second request unit; and
a communication unit configured to perform communication with said other wireless apparatus when said other wireless apparatus transitions into a communication mode for performing communication after the setting is performed by the execution unit.

5. The wireless apparatus according to claim 4, wherein
the first request unit includes information for identifying the transmission source in a request, and
the second request unit includes the information for identifying the transmission source in a request.

6. A communication method comprising:
receiving, from another wireless apparatus for which a setting related to the wireless network is not configured, a request for making a transition into a preparation mode for preparing the setting;
making a transition into the preparation mode when the received request needs to be satisfied;
performing, when the transition into the preparation mode is made, the setting related to a wireless network with said other wireless apparatus by making a transition into an execution mode for performing the setting upon the receipt of a setting request from said other wireless apparatus; and
performing communication with said other wireless apparatus by making a transition into a communication mode for performing communication after the setting is performed, wherein,
in performing the setting, the transition into the execution mode is rejected during the communication mode even when a setting request from said other wireless apparatus is received.

7. A communication method comprising:
requesting another wireless apparatus, for which a setting related to a wireless network is not configured, to transition into a preparation mode for preparing the setting;
requesting said other wireless apparatus to make a setting when said other wireless apparatus transitions into the preparation mode in accordance with the transition request;
performing the setting related to the wireless network with said other wireless apparatus when said other wireless apparatus transitions into an execution mode for performing the setting in accordance with the setting request; and
performing communication with said other wireless apparatus when said other wireless apparatus transitions into a communication mode for performing communication after the setting is performed.

8. A wireless apparatus comprising:
an execution unit configured to perform a setting related to a wireless network with another wireless apparatus for which the setting related to the wireless network is not configured and to manage setting contents; and
a communication unit configured to perform communication with said other wireless apparatus for which the setting is performed by the execution unit, wherein
the execution unit deletes setting contents for another wireless apparatus that has not performed communication with the communication unit over a certain period of time.

9. A communication method comprising:
performing a setting related to a wireless network with another wireless apparatus for which the setting related to the wireless network is not configured;
managing the setting contents; and
performing communication with said other wireless apparatus for which the setting is performed, wherein,
in managing the setting contents, the setting contents are deleted for another wireless apparatus that has not performed communication over a certain period of time.
